(19) United States
(12) Patent Application Publication
(10) Pub. No.: US 2018/0015594 A1
(43) Pub. Date: Jan. 18, 2018

(54) Locking Device for Adjustable Wrench Jaw

(71) Applicant: Brendan Laiben, Festus, MO (US)

(72) Inventor: Brendan Laiben, Festus, MO (US)

(21) Appl. No.: 15/210,338

(22) Filed: Jul. 14, 2016

(51) Int. Cl. B25B 13/22; B25B 13/14

(52) U.S. Cl. CPC B25B 13/22; B25B 13/14

(57) ABSTRACT

Systems, method, and apparatus for locking a movable component of a tool into an operationally static position. A locking mechanism embedded within an interior cavity of a tool is operationally connected to a squeeze handle via a linkage assembly. When the handle is squeezed, the linked assembly drives the locking mechanism toward the movable component. Corresponding gear racks on the locking element and movable element inhibit movement in both vectors, using a zero degree pressure angle to strongly inhibit movement in another factor, and using a non-zero degree pressure angle to less firmly inhibit movement in an opposing vector.

### BACKGROUND OF THE INVENTION

### Field of the Invention

This disclosure pertains to the field of hand tools, and more particularly to systems, methods and apparatus for locking a movable part of a tool in place.

### Description of the Related Art

Repetitive strain injury is an injury to the musculoskeletal and/or nervous systems caused by repetitive tasks and, in particular, tasks that involve vibration, compression, uncomfortable positions, or forceful exertion. Carpal tunnel syndrome is a common example of repetitive strain injuries, caused by prolonged use of computer keyboards, but many other varieties exist. Musculoskeletal disorders (“MSDs”) create particular difficulty for laborers and contractors, whose livelihoods depend upon the ability to consistently and precisely operate tools and machinery. According to a report from the Occupational Safety and Health Administration, in 2010, 25% of construction injuries were from MSDs, and 39% of construction injuries were from some kind of strain or sprain. According to the U.S. Bureau of labor Statistics, from 1992 to 2009, laborers consistently experienced more lost work days from. MSDs than from any other type of injury. The economic cost of overexertion is estimated to be well in excess of $12.75 billion annually and accounted for 25% of all workers' compensation costs.

Common factors in MSDs include awkward postures, repetition, excessive force, and poorly designed tools. Many laborers perform the same types of tasks repeatedly throughout the day, using the same types of tools. If the tools are poorly designed, or require exertion of force, the repetitive use can result in unnecessary strain and injury. For example, a simple wrench requires the application of three via both the grip and rotational force applied to the handle. When used hundreds of times per day, the repeated application of force by use of a trench can injure or damage tendons and muscles, as well as cause fatigue, in terms of both handle muscles from maintaining grip, and wrist and arm muscles from applying rotational force.

Further complicating this problem, particularly for wrenches, is that adjustable wrenches tend to require constant adjustment. This wastes time and adds another level of repetitive strain, as adjustable wrenches generally use a thumb-operated helical screw to adjust the jaws. Prior art wrenches with locking mechanisms either include the locking media mechanism as a separate component operable by manual manipulation, requiring the worker to have a hand free, or require the continuous application of grip pressure, further exacerbating repetitive strain.

What is needed in the art is a locking system for locking adjustable tool parts into place without requiring the continued application of significant pressure, and without requiring a free hand. A device, including such a system, could both reduce injury among laborers and help other users with compromised hand strength, such as the injured or elderly, make proper and safe use of tools while reducing risk of injury.

### SUMMARY OF THE INVENTION

The following is a summary of the invention in order to provide a basic understanding of some of its aspects. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a system for locking a movable element of a tool comprising: a main body rigidly attached to a fixed handle; a hollow cavity in the main body; and a channel through the main body, the channel intersecting the cavity; a movable element of the tool, the movable element comprising a movable element gear rack having a plurality of teeth, the gear rack being at least partially disposed in the channel such that at least some of the plurality of teeth are in the cavity; a locking element disposed in the cavity, the locking element comprising a locking element gear rack corresponding to the movable element gear rack, and the locking element sized and shaped to fit in the cavity such that the locking element has only two opposing movement vectors when disposed in the cavity, one of the two opposing movement vectors being toward the intersection of the channel and the cavity; a linkage assembly having a first end and an opposing second end, the linkage assembly being rotationally coupled to the locking element at the first end, and the linkage assembly being disposed in the tool; and a movable handle having an elongated gripping element rigidly attached to a head portion, the head portion rotationally coupled to the main body and rotationally coupled to the linkage assembly at the second end; wherein when the elongated gripping element is moved, the head portion rotates at the coupling to the main body to cause the linkage assembly to drive the locking element along the movement vector toward the intersection to interlock the locking element gear rack with the movable element gear rack.

In an embodiment of the system, the tool is a wrench.

In another embodiment of the system, the movable element is a movable jaw assembly.

In a further embodiment of the system, the movable jaw assembly includes a wrench jaw.

In a still further embodiment of the system, the wrench further comprises a fixed jaw rigidly attached to the main body.

In a still further embodiment of the system, the channel is disposed in the main body such that when the movable element is disposed in the channel, the wrench jaw is disposed adjacent to the fixed jaw.

In a still further embodiment of the system, the fixed jaw and the wrench jaw each comprise a tapered gripping surface.

In another embodiment of the system, the tool further comprises a retention means for causing the movable element to return to neutral.

In a still further embodiment of the system, the retention means is a spring.

In another embodiment of the system, each tooth in the plurality of teeth has a pressure angle of about 0°.

In a further embodiment of the system, the locking element gear rack comprises a plurality of teeth and each tooth in the locking element gear rack plurality of teeth has a pressure angle of about 0°.

In another embodiment of the system, the locking element gear rack is disposed on a side of the locking element, and the locking element is rotationally attached to the linkage assembly at an end of the locking element opposing the gear rack.

Also described herein, among other things, is a method for locking a movable element of a tool in place comprising: providing a tool comprising: a main body rigidly attached to a fixed handle; a cavity in the main body; and a channel through the main body; a movable element of the tool comprising a tool component rigidly attached to a movable element gear rack at least partially disposed in the channel such that at least part of the gear rack is also in the hollow cavity; a locking element disposed in the cavity and having a locking element gear rack configured to interlock with the movable element gear rack; a linkage assembly rotationally coupled to the locking element; and a movable handle having a head portion rotationally coupled to the linkage assembly and separately rotationally coupled to the main body; a user of the tool squeezing the movable handle and the fixed handle together; the squeezing step rotating the head portion at the coupling to the main body; and the rotation of the head portion driving the locking element via the linkage assembly to interlock with the movable element in the cavity via the gear rack.

In a embodiment of the method, the tool is a wrench.

In another embodiment of the method, the movable element is a movable jaw assembly.

In a further embodiment of the method, the movable jaw assembly includes a wrench jaw.

In a still further embodiment of the method, the wrench jaw is disposed adjacent to the fixed jaw.

In a still further embodiment of the method, the fixed jaw and the wrench jaw each comprise a tapered gripping surface.

In another embodiment of the method, the each tooth in the plurality of teeth has a pressure angle of about 0°.

In a still further embodiment of the method, the locking element gear rack comprises a plurality of teeth and each tooth in the locking element gear rack plurality of teeth has a pressure angle of about 0°.

### BRIEF DESCRIPTION OF THE DRAWINGS

FIG. 1 provides an isometric cutaway drawing of a wrench including an embodiment of the locking mechanism according to the present disclosure.

FIG. 2 provides a side elevation cutaway drawing of a wrench including an embodiment of the locking mechanism according to the present disclosure.

FIG. 3 provides an alternative isometric cutaway drawing of a wrench including an embodiment of the locking mechanism according to the present disclosure.

FIG. 4 provides a more detailed isometric cutaway drawing of a wrench including an embodiment of the locking mechanism according to the present disclosure.

FIG. 5 provides an isometric cutaway drawing of a wrench including an embodiment of the locking mechanism according to the present disclosure, wherein the locking mechanism is engaged in locking position.

FIG. 6 provides an exploded view of the components of a wrench including an embodiment of the locking mechanism according to the present disclosure.

### DETAILED DESCRIPTION OF PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Generally, described herein are systems and methods for locking a movable element of a tool or other object in place. Although this disclosure describes the apparatus and methods in conjunction with a wrench, the systems and methods described herein are suitable for use in any tool or object where it is desired for a user of the tool or object to lock a movable element of the tool or object in place with little application of force required.

At a high level, the system includes a movable handle (105) for operating the locking system, and the locking system itself is disposed within the main body (102) of the wrench (101). The movable handle (105) is operatively connected to a locking element (113) via a linkage assembly (115). When the movable handle (105) is operated, the rotation of the movable handle (105) causes the linkage assembly (115) to drive the locking element (113) into a locked position in which the locking element (113) interacts with a movable element (109) to inhibit the movable element (109) from moving. These and other components are described in further detail herein.

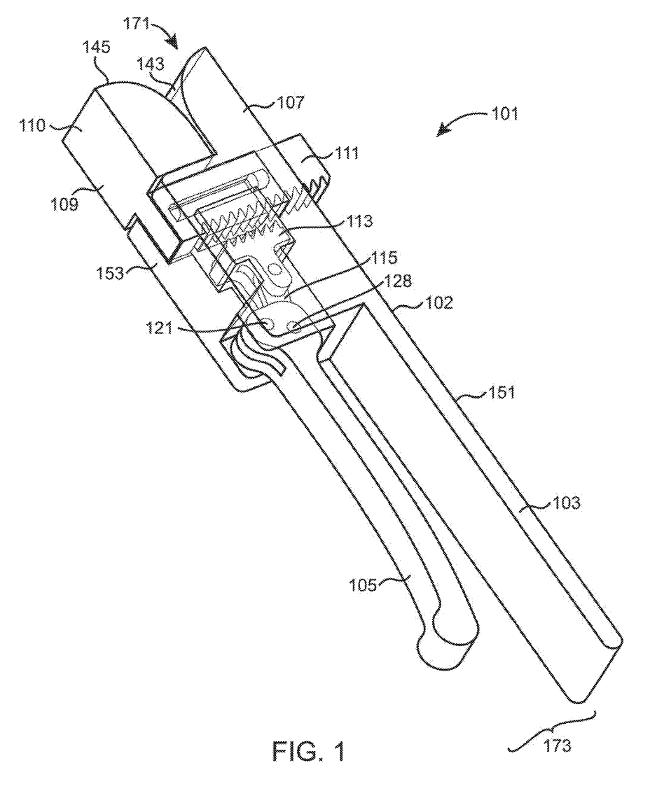

FIG. 1 depicts a cutaway view of a tool, i.e., a wrench (101), including an embodiment of the systems and methods described herein. The depicted wrench (101) comprises a main body (102) and a fixed handle (103) rigidly attached thereto. The depicted main body (102) and handle (103) are constructed as a single component, adding strength to the wrench (101). The main body (102) further includes a fixed jaw (107) disposed at an end of the main body (102) opposing end having the fixed handle (103). This end (171) is referred to as the “distal end” (171) of the tool (101). The opposing end (173) can also be referred to as the “proximal end” (173). The depicted fixed jaw (107) has tapered gripping surface (143) for both ease-of-use and auto-sizing the position of the movable jaw (109), described elsewhere herein.

The fixed handle (103) is generally sized and shaped to comfortably accommodate the grip of the intended user, generally an adult human. However, for particular applications, the fixed handle (103) may be sized and shaped otherwise to accommodate a different intended user. By way of example and not limitation, where a tool is intended for use by a school-aged child, the fixed handle (103) may be sized and shaped to comfortably accommodate a school-aged child. In certain embodiments, the main body (102) and fixed handle (103) may be the same or similar components, constructed as a single monolithic piece.

The size and shape of the main body (102) will necessarily vary depending upon the particular tool (101) in which the locking system is disposed, but will generally include a hollow cavity (137) disposed within the main body (102). When the tool (101) is assembled, the cavity (137) is generally enclosed. This improves operational life by inhibiting foreign debris or materials from entering the cavity (137) and interfering with the operation of those components of the locking system disposed in the cavity (137).

The depicted tool (101) of FIG. 1, a wrench (101), further comprises a movable element (109). In the depicted embodiment of a wrench (101), the movable element (109) includes a wrench jaw (110) rigidly attached to a gear rack (111). The movable element (109) is generally a separately manufactured component, meaning it is not constructed as part of the main body (102) or fixed handle (103), but rather is removable and separable from the main body (102) and fixed handle (103).

The depicted movable jaw (110) is disposed on the movable element (109) such that its (110) major lengthwise axis is generally perpendicular to the major lengthwise axis of the gear rack (111). When the depicted movable element (109) is disposed in the tool (101), the major lengthwise axis of the movable jaw (110) is generally parallel to that of the fixed jaw (107). This allows the two jaws (107) and (110) to cooperate to grip a fastener or other object to which the user desires to apply rotational force via the tool (101). Like the fixed jaw (107), the movable jaw (110) is tapered on the gripping surface (145), which faces and opposes the gripping surface (143) of the fixed jaw (107), also improving ease-of-use and facilitating the automatic sizing feature described elsewhere herein. As with the fixed jaw (107), the depicted movable element (110) is disposed at the distal end (171) of the main body (102).

The gear rack (111) is generally in the configuration of a rectangular prism having a set of similarly-sized and similarly-shaped teeth disposed on a surface thereof. The surface having the teeth is generally opposing the side to which the jaw (110) is attached. Because the depicted jaw (110) is oriented on the distal end (171) of the main body (102), the gear rack (111) points in the opposite direction, back towards the proximal end (173).

When the depicted tool (101) is assembled, the movable element (109) is partially disposed within the main body (109). This is generally done by disposing the gear rack (111) within a channel (123) through the main body (102), which channel (123) intercepts the cavity (137). In the depicted embodiment, the channel (123) intercepts the cavity (137) at the end of the cavity (137). The channel (123) is disposed generally perpendicular to the major axis of the tool (101) (i.e., perpendicular to the major axis of the main body (102) and fixed handle (103)). Thus, when the movable element (109) is disposed in the channel (123), the jaw (110) is disposed on the distal end (171), and the gear rack (111) faces the opposite direction, pointing back towards the proximal end (173), but because the gear rack (111) is disposed in the channel (123), it is generally contained within the main body (102). The portion of gear rack (111) in the portion of channel (123) intercepting the cavity (137) is exposed to the interior of the cavity (137).

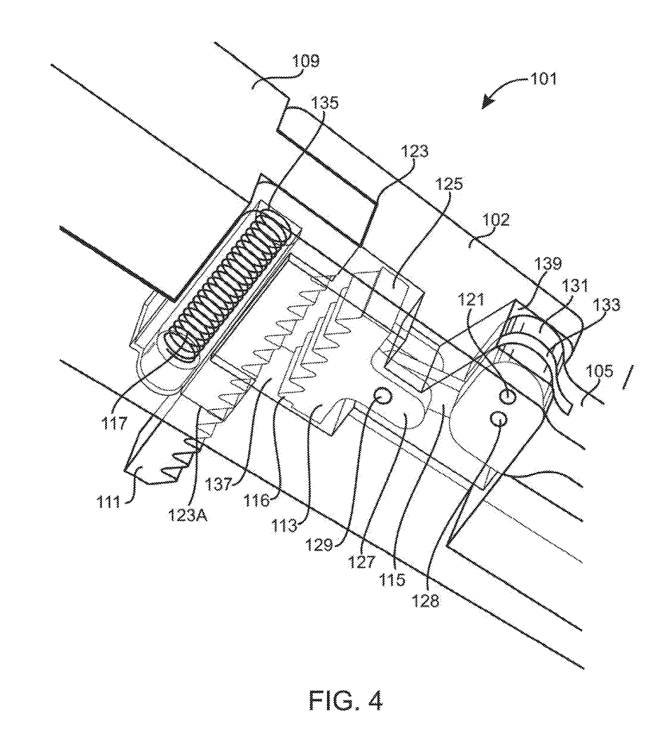

As can be seen in FIG. 4, the gear rack (111) is generally a thinner component than the jaw (110). This is so that the overall thickness of the tool (101) can remain generally uniform. That is, the thickness of the movable jaw (110) should generally correspond to that of the fixed jaw (107). However, if the gear rack (111) is the same thickness as the jaw (110), it cannot be disposed within the main body (102) unless the main body (102) is even thicker. Such a configuration would be unwieldy, unnecessarily heavy, and visually unappealing. In the depicted embodiment, the gear rack (111) is thinner and configured to snugly slide into the channel (123) so that the overall thickness of the tool (101) remains somewhat uniform.

As can be further seen in FIG. 4, the channel (123) becomes a bore (123A) or tunnel (123A) through part of the main body (102). The channel (123) begins on the side (153) of the tool distal to the fixed jaw (107), passes through the main body (102), intersecting the interior hollow cavity (137), and then continues generally linearly through the main body (102) as a bore (123A), exiting on the side (151) of the main body (102) proximal to the fixed jaw (107).

This structure has several advantages. First, it allows the movable element (109) to be “opened” further, by allowing for an elongated gear rack (111) that may pass through the bore (123A) and extend beyond the proximal side (153) of the tool (101) when the jaws (107) and (110) are closed. This in turn facilitates wider jaw (107) and (110) separation, because when the jaws (107) and (110) open, the gear rack (111) slides through the main body (102) towards the distal side (153). The longer the gear rack (111), the greater distance the movable element (109) can slide without becoming separated from the main body (102).

Another advantage is that this structure allows room for a retention means (117) for the movable element (109). That is, if the movable element (109) slides far enough, the gear rack (111) will no longer be held within the channel (123) or bore (123A), and the movable element (109) may become disconnected from the main body (102). To inhibit this, a retention means (117) may be included, inhibiting the movable element (109) from becoming so far displaced as to fall out of the main body (102).

In the depicted embodiment, the retention means (117) is a coil (117) or spring (117). The depicted spring (117) is disposed within a second channel (135) or cavity (135) in the main body (102), and is generally disposed parallel to the primary movement vectors of the movable element (109). One end of the spring (117) is connected to the main body (102), and the other is connected to the movable element (109). Thus, when the movement element (109) is displaced from the neutral position (i.e., jaws (107) and (110) adjacent), the spring (117) extends and exerts tensile pressure on the movable element (109), the tensile pressure having a force vector opposing the movement of the movable element (109)—i.e., the spring (117) tends to pull the movable element (109) back to neutral. The depicted spring (117) is disposed in a second cavity (135) or second channel (135) disposed in the main body (102) between the distal end (171) and the channel (123). This structure disposes the spring (117) such that it does not interfere with the locking system described elsewhere herein.

Referring to FIG. 4, an embodiment of a locking system according to the present disclosure is shown. The locking system generally comprises a locking element (113) disposed in the cavity (137) and rotationally and operatively coupled to a linkage assembly (115). In the depicted embodiment, this coupling is via a pin (129). The locking element (113) comprises a body portion (125) having a gear rack (116) disposed on a surface thereof, and an attaching portion (127) disposed on a side of the body portion (125) opposing the gear rack (116). The gear rack (116) is sized, shaped, and disposed on the body portion (125) such that the locking element gear rack (116) and the movable element gear rack (111) interconnect in a locked configuration that inhibits movement of the movable element (109).

As can be further seen in FIG. 4, this is done through the shape of the teeth, which generally have a flat vertical side and an opposing angled side. The gear racks (111) and (116) are disposed on their respective components (109) and (113) such that when the gear racks (111) and (116) are pressed together, the flat vertical sides of the teeth on each gear rack (111) and (116) are adjacent. That is, the pressure angle of the teeth is 0° on one side, and the gear racks (111) and (116) interlock such that the 0° pressure angle sides the teeth in each gear rack (111) and (116) are adjacent. This differs from conventional gear racks, which have non-zero symmetric pressure angles to facilitate interlocking with a rotating gear. This inhibits movement of the movable element (109) in a vector towards the distal side (153), but allows the movable element (109) to more easily slide back to neutral without fully disengaging the locking element (113), as the sides of teeth with non-zero pressure angles can more easily slide past each other if the locking element (113) pressure is relaxed.

The locking element (113) is sized, shaped, and disposed in the cavity (137) such that it effectively has only two significant movement vectors—an engagement vector, and a disengagement vector. That is, the width of the locking element (113) is about the same as the width of the cavity (137), so that the locking element (113) moves only toward (engagement vector) and away from (disengagement vector) the distal (171) end. The locking element (113) is driven along these vectors via the operational coupling to the linkage assembly (115), which in turn is rotationally and operatively coupled to a movable handle (105). In the depicted embodiment, this coupling is via a pin (128).

As can be seen from the Figures, the movable handle (105) comprises an elongated handle portion and a head portion (131), and is attached to the main body (102) via the head portion (131), which is disposed in a channel (139) or recess (139) in the main body (102). In the depicted embodiment, this recess (139) is near the proximal end (173) of the device (101), where the fixed handle (103) is attached to the main body (102). The movable handle (105) is also rotationally coupled to the main body (102) via a pin (121) in the head portion (131), with the elongated handle portion extending generally alongside the fixed handle (103). The movable handle (105) is operated by squeezing it towards the fixed handle (103).

The locking system operates via the couplings among the movable handle (105), linkage assembly (115), and locking element (113). When the movable handle (105) is squeezed, the head portion (131) rotates around the pin (121). Because the linkage assembly (115) is rotationally coupled to the head portion (131) via another pin (128), and that other pin (128) is not radially centered on the bead portion (131), the rotating of the head portion (131) causes the pin (128) to move circumferentially around the centered pin (121). The linkage assembly (115), being operatively coupled to the head portion (131) via this pin (128), in turn is urged in a movement vector toward the distal end (171). The locking element (113), being operatively coupled to the linkage assembly (115) via a pin (129), is likewise urged in a movement vector to the distal end (171). Because the locking element (113) is sized and shaped to have only two significant movement vectors within the cavity (137), the locking mechanism (113) is driven toward that portion of the gear rack (111) of the movable element (109) exposed to the cavity (137), until the two gear racks (111) and (116) interlock, thereby engaging the locking system. The rotational coupling via pins (129) and (121) allows the rotational motion of the head portion (131) to be transferred and translated into a linear movement vector of the locking mechanism (113) via the linkage assembly (115).

In the depicted embodiment, the main body (102) further comprises one or more additional cavities sized and shaped to accommodate the linkage assembly (115) and head portion (131). For example, in the depicted embodiment, the head portion (131) is disposed in a recess (139) as previously described, and a further cavity or opening is disposed within the main body, connecting the head recess (139) to the cavity (137), and the linkage assembly (115) is disposed within this further cavity or opening. This cavity or opening (137) is sized and shaped to accommodate the full range of motion of the linkage assembly (115) as the movable handle (105) is operated.

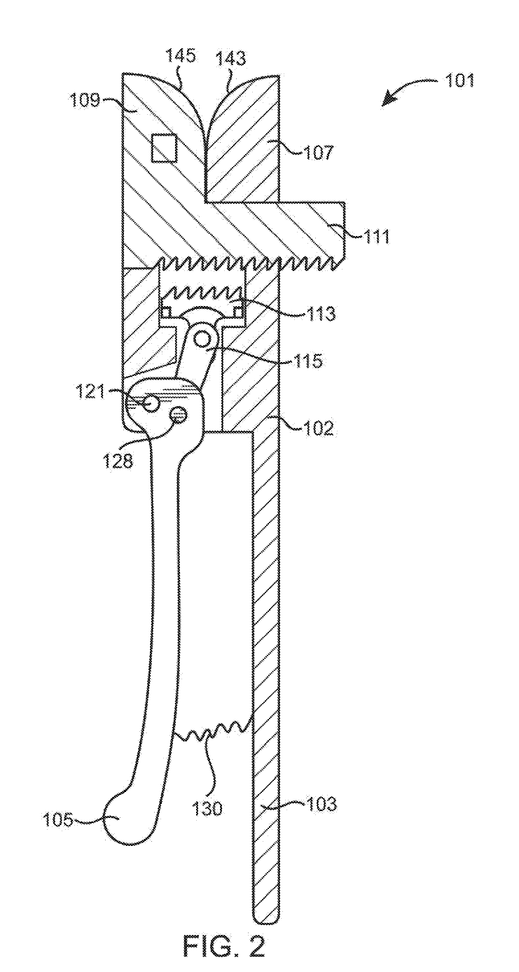

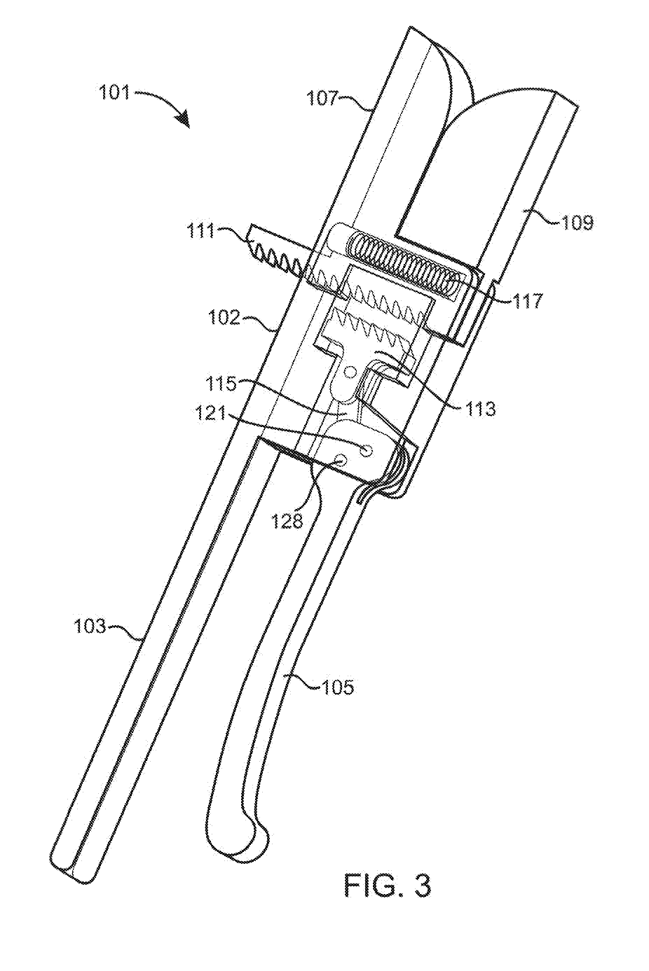

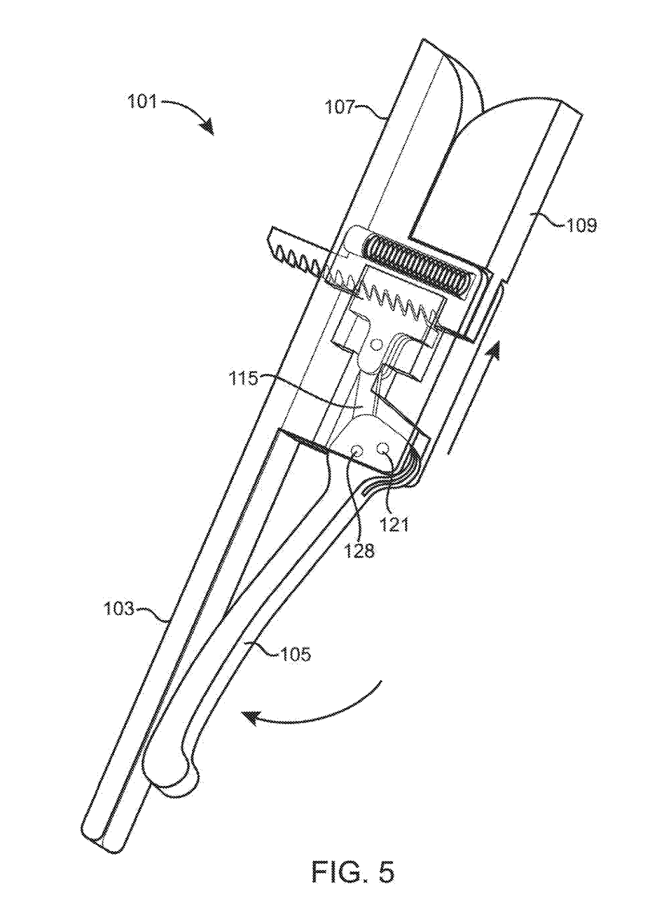

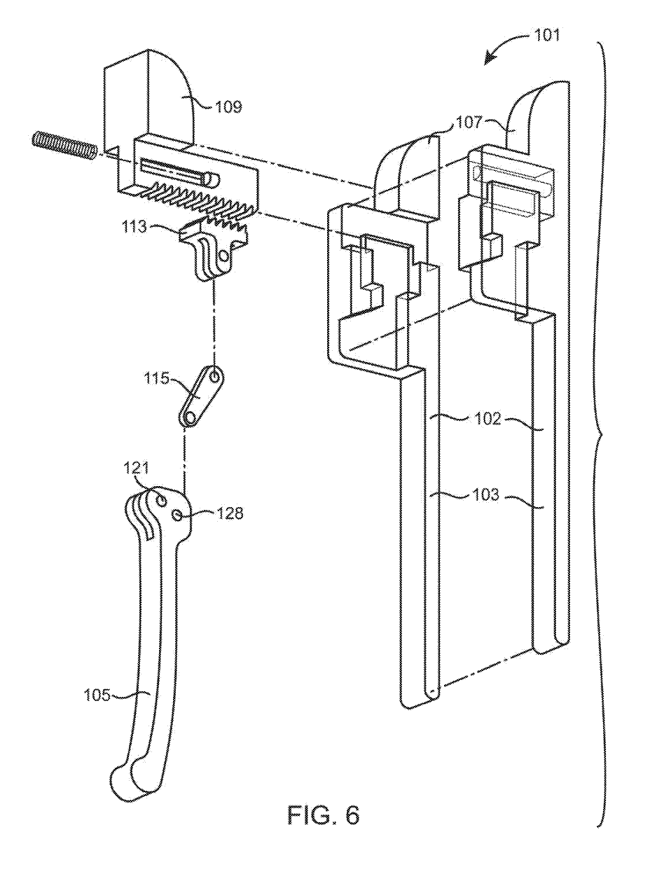

Alternative views of the locking mechanism are depicted in FIGS. 2 and 3, and a view of the mechanism in a locked position is depicted in FIG. 5. Finally, an exploded view in FIG. 6 shows all components separately.

Another aspect of the present disclosure is an auto-sizing feature. This aspect uses a tapered jaw (107) and (110) shape to allow a user to start the jaws in a closed position and then insert the fastener or other object upon which the tool's force is to be applied between the jaws (107) and (110). Generally, the locking mechanism is in an unlocked position when using this feature. The tapered gripping surfaces (143) and (145) of the jaws (107) and (110) face each other, so that when the closed jaws (107) and (110) are pressed against a fastener, the fastener pushes the jaws (107) and (110) apart a sufficient amount for the fastener to be snugly held between the jaws (107) and (110). The locking system can then be engaged, locking the jaws (107) and (110) in place at the appropriate width to snugly hold the fastener.

Generally, fasteners are manufactured in standard sizes according to a measurement system, chiefly metric or imperial units. The tooth width and distance between teeth for the gear racks (111) and (116) (e.g., circular pitch in a conventional gear rack) may be configured for particular unit systems. That is, when the locking system is engaged, the jaws (107) and (110) lock into positions that create jaw widths corresponding to fastener widths for a particular unit system. For example, the gear racks (111) and (116) may be configured to lock the jaws (107) and (110) in positions that create a gap between the jaws (107) and (110) of appropriate widths to work fasteners having metric or imperial dimensions. In a further embodiment, the gear racks (111) and (116) may have variable or irregular circular pitches, allowing a single tool to lock into both metric and imperial unit widths.

The device may further include a spring, coil, or tension device (130) disposed between the fixed handle (103) and the movable handle (105) in order to inhibit unintended movement. Additionally, in an embodiment, the jaws may be actuated to the open position by operation of the movable handle away from both the neutral position and locked position, such that the user can spread the jaws apart like scissors.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A system for locking a movable element of a tool comprising:
a tool comprising:
a main body rigidly attached to a fixed handle;
a hollow cavity in said main body; and
a channel through said main body, said channel intersecting said cavity;
a movable element of said tool, said movable element comprising a movable element gear rack having a plurality of teeth, said gear rack being at least partially disposed in said channel such that at least some of said plurality of teeth are in said cavity;
a locking element disposed in said cavity, said locking element comprising a locking element gear rack corresponding to said movable dement gear rack, and said locking element sized and shaped to fit in said cavity such that said locking element has only two opposing movement vectors when disposed in said cavity, one of said two opposing movement vectors being toward said intersection of said channel and said cavity;
a linkage assembly having a first end and an opposing second end, said linkage assembly being rotationally coupled to said locking element at said first end, and said linkage assembly being disposed in said tool; and
a movable handle having an elongated gripping element rigidly attached to a head portion, said head portion rotationally coupled to said main body and rotationally coupled to said linkage assembly at said second end;
wherein when said elongated gripping element is moved, said head portion rotates at said coupling to said main body to cause said linkage assembly to drive said locking element along said movement vector toward said intersection to interlock said locking element gear rack with said movable element gear rack.

2. The system of claim 1, wherein said tool is a wrench.

3. The system of claim 1, wherein said movable element is a movable jaw assembly.

4. The system of claim 2, wherein said movable aw assembly includes a wrench jaw.

5. The system of claim 4, wherein said wrench further comprises a fixed jaw rigidly attached to said main body.

6. The system of claim 5, wherein said channel is disposed in said main body such that when said movable element is disposed in said channel, said wrench jaw is disposed adjacent to said fixed jaw.

7. The system of claim 6, wherein said fixed jaw and said wrench jaw each comprise a tapered gripping surface.

8. The system of claim 1, wherein said tool further comprises a retention means for causing said movable element to return to neutral.

9. The system of claim 8, wherein said retention means is a spring.

10. The system of claim 1, wherein each tooth in said plurality of teeth has a pressure angle of about 0°.

11. The system of claim 10, wherein said locking element gear rack comprises a plurality of teeth and each tooth in said locking element gear rack plurality of teeth has a pressure angle of about 0°.

12. The system of claim 1, wherein said locking element gear rack is disposed on a side of said locking element, and said locking element is rotationally attached to said linkage assembly at an end of said locking element opposing said gear rack.

13. A method for locking a movable element of a tool in place comprising:
providing a tool comprising:
a main body rigidly attached to a fixed handle;
a cavity in said main body; and
a channel through said main body;
a movable element of said tool comprising a tool component rigidly attached to a movable element gear rack at least partially disposed in said channel such that at least part of said gear rack is also in said hollow cavity;
a locking element disposed in said cavity and having a locking element gear rack configured to interlock with said movable element gear rack;
a linkage assembly rotationally coupled to said locking element; and
a movable handle having a head portion rotationally coupled to said linkage assembly and separately rotationally coupled to said main body;
a user of said tool squeezing said movable handle and said fixed handle together;
said squeezing step rotating said head portion at said coupling to said main body; and
said rotation of said head portion driving said locking element via said linkage assembly to interlock with said movable element in said cavity via said gear rack.

14. The method of claim 13, wherein said tool is a wrench.

15. The method of claim 13, wherein said movable element is a movable jaw assembly.

16. The method of claim 15, wherein said movable jaw assembly includes a wrench jaw.

17. The system of claim 16, wherein said wrench jaw is disposed adjacent to said fixed jaw.

18. The method of claim 17, wherein said fixed jaw and said wrench jaw each comprise a tapered gripping surface.

19. The method of claim 13, wherein said each tooth in said plurality of teeth has a pressure angle of about 0°.

20. The method of claim 19, wherein said locking element gear rack comprises a plurality of teeth and each tooth in said locking element gear rack plurality of teeth has a pressure angle of about 0°.
